(19) United States
(12) Patent Application Publication
(10) Pub. No.: US 2025/0223150 A1
(43) Pub. Date: Jul. 10, 2025

(54) FUEL TREATMENT SYSTEM FOR RETAIL FUELING STATIONS AND RELATED METHODS

(71) Applicant: Total Meter Services Inc., Toronto (CA)

(72) Inventors: Dennis SWANEK, Toronto (CA); Jasdeep PANAG, Toronto (CA)

(21) Appl. No.: 19/094,152

(22) Filed: Mar. 28, 2025

Related U.S. Application Data
(63) Continuation of application No. PCT/CA2023/051282, filed on Sep. 28, 2023.

(30) Foreign Application Priority Data
Sep. 29, 2022 (CA) 3177894

(51) Int. Cl. B67D 7/76; B01F 23/451; B01F 25/314; B01F 25/452; B01F 101/00; B67D 7/04; B67D 7/74; C10L 1/02

(52) U.S. Cl. CPC B67D 7/76; B01F 23/451; B01F 25/3141; B01F 25/3142; B01F 25/4521; B67D 7/04; B67D 7/743; C10L 1/02; B01F 2101/503; C10L 2290/143

(57) ABSTRACT

A retail fueling station includes: (a) a fuel supply line extending between a fuel storage tank and a fuel dispensing system; (b) a treatment fluid supply line coupled to a treatment fluid storage tank; and (c) a treatment fluid injection system including: (i) a mixing conduit mounted to the fuel supply line and through which untreated fuel flows when conducted through the fuel supply line from the fuel storage tank toward the fuel dispensing system; (ii) one or more pressure reducers in the mixing conduit for providing a reduced pressure region immediately downstream of each pressure reducer; and (iii) one or more injection ports in the mixing conduit for injection of treatment fluid received from the treatment fluid supply line into corresponding reduced pressure regions for mixture with the untreated fuel flowing through the mixing conduit to produce treated fuel.

### CROSS-REFERENCE TO RELATED APPLICATIONS

This application is a continuation of International Application No. PCT/CA2023/051282 filed Sep. 28, 2023, which claims priority from Canada Patent Application No. 3,177,894 filed Sep. 24, 2022, the entire contents of which are hereby incorporated by reference for all purposes.

### FIELD

The specification relates generally to fuel treatment, and more specifically, to fuel treatment systems for retail fueling stations.

### BACKGROUND

International Pub. No. WO 2019/237198 (Swanek et al.) discloses an additive injection system including an additive injection controller operable to: (a) receive fuel data; (b) determine, from the fuel data, a total fuel amount corresponding to a total volume of fuel present in a fuel tank; (c) determine an untreated fuel amount corresponding to a delivered volume of untreated fuel delivered into the fuel tank, the untreated fuel amount determined based on the total fuel amount and a treated fuel amount corresponding to an expected volume of treated fuel expected to be present in the fuel tank; and (d) in response to determining that the untreated fuel amount exceeds an injection threshold, generate an injection signal to initiate injection of fuel additive into a fuel stream of untreated fuel being delivered into the fuel tank via the fuel tank inlet.

U.S. Pat. No. 5,944,074 (Leahy et al.) discloses an interchangeable additive injection apparatus providing a plurality of flow paths from one or more upstream additive tanks to one or more downstream fuel containers. A plurality of additive lines converge into an additive conduit at a manifold disposed within the apparatus. A plurality of valves associated with the additive lines are selectively opened and closed to isolate one of the flow paths. A metering device is disposed along the additive conduit for measuring the flow of additive therethrough. A reversible, multiple port housing surrounds at least the valves and manifold. In a forward orientation, a plurality of upstream ports are coupled to upstream additive tanks, and a downstream port is coupled to a fuel tank. By reversing the housing, the apparatus is placed in a reverse orientation wherein the upstream port is connected to an upstream additive tank and a plurality of downstream ports are connected to downstream fuel tanks. In either orientation, an expansion apparatus may be coupled to an expansion port on the additive injection apparatus to provide a number of additional ports and flow paths. A controller is coupled with the injection apparatus to monitor and control the associated pumps, valves, and meters.

International Pub. No. WO 90/03329 (Hayden et al.) discloses an additive delivering system including an interface fitting between a product delivery hose and a product receiving connection. The fitting is keyed to the product receiving connection in such a manner that the fitting must be attached to the product receiving connection before product flow can be delivered from the product delivery hose to the product receiving connection. An injection mechanism is connected to the fitting for automatically injecting additive to the product flow through the fitting.

### SUMMARY

The following summary is intended to introduce the reader to various aspects of the applicant's teaching, but not to define any invention.

According to some aspects, a retail fueling station is configured to treat untreated fuel to produce treated fuel for delivery to end users at the retail fueling station. The retail fueling station includes: (a) a fuel dispensing system including at least one fuel dispenser for dispensing treated fuel to the end users; (b) a fuel supply system including an underground fuel storage tank for storing untreated fuel, a fuel supply line extending between the fuel storage tank and the fuel dispensing system, and a fuel pump coupled to the fuel supply line for pumping the untreated fuel from the fuel storage tank toward the fuel dispensing system through the fuel supply line; (c) a treatment fluid supply system including a treatment fluid storage tank for storing a treatment fluid, a treatment fluid supply line coupled to the treatment fluid storage tank for receiving the treatment fluid therefrom, and a treatment fluid pump coupled to the treatment fluid supply line for pumping the treatment fluid from the treatment fluid storage tank through the treatment fluid supply line; and (d) a treatment fluid injection system including: (i) a mixing conduit mounted to the fuel supply line. The mixing conduit has a conduit inlet in fluid communication with an upstream portion of the fuel supply line for receiving the untreated fuel from the fuel storage tank, a conduit outlet in fluid communication with a downstream portion of the fuel supply line for discharging the treated fuel toward the fuel dispensing system, and a fluid passage extending through the conduit between the conduit inlet and the conduit outlet along a passage axis. The mixing conduit further includes (ii) a plurality of orifice plates arranged in series in the mixing conduit. The orifice plates are spaced axially apart from each other along the passage axis and axially separate the fluid passage into a plurality of mixing chambers. Each orifice plate has a restriction orifice sized for providing a reduced pressure region in the mixing chamber immediately downstream of the orifice plate. The mixing conduit further includes (iii) a plurality of injection ports in the mixing conduit. Each injection port has a port inlet for receiving treatment fluid from the treatment fluid supply line and a port outlet open to the reduced pressure region of a corresponding mixing chamber for injection of the treatment fluid therein for mixture with untreated fuel flowing through the mixing chamber.

In some examples, the fuel supply system is configured to supply the untreated fuel to the conduit inlet at a supply pressure, the treatment fluid supply system is configured to supply the treatment fluid to each injection port at an injection pressure equal to or less than the supply pressure, and each reduced pressure region provides a reduced fluid pressure that is less than the injection pressure.

In some examples, the fuel supply line is defined by a supply line inner diameter and each mixing chamber is defined by an expanded inner diameter. The expanded inner diameter is greater than the supply line inner diameter.

In some examples, the conduit inlet and outlet are generally cylindrical and defined by respective inlet and outlet inner diameters. Each of the inlet and outlet inner diameters correspond to the supply line inner diameter. The mixing conduit has a cylindrical expanded section defined by the expanded inner diameter and in which the orifice plates and mixing chambers are located.

In some examples, the mixing conduit has a conical divergent section between the conduit inlet and the expanded section and expanding radially in a downstream direction from the inlet inner diameter to the expanded inner diameter, and a conical convergent section between the expanded section and the conduit outlet and converging radially in the downstream direction from the expanded inner diameter to the outlet inner diameter.

In some examples, the restriction orifice of each orifice plate is defined by a corresponding orifice diameter, and each orifice diameter is greater than the supply line inner diameter and less than the expanded inner diameter.

In some examples, the restriction orifices of at least two of the orifice plates are eccentric relative to each other.

In some examples, the restriction orifice of at least one of the orifice plates is eccentric relative to at least one of the conduit inlet and the conduit outlet.

In some examples, the plurality of orifice plates include an upstream orifice plate adjacent the conduit inlet, a downstream orifice plate adjacent the conduit outlet, and one or more intermediate orifice plates between the upstream and downstream orifice plates.

In some examples, the restriction orifice of the upstream orifice plate is defined by an upstream orifice diameter, the restriction orifice of the downstream orifice plate is defined by a downstream orifice diameter, and the restriction orifice of each intermediate orifice is defined by a corresponding intermediate orifice diameter. The upstream orifice diameter is greater than the downstream and intermediate orifice diameters. In some examples, the intermediate and downstream orifice diameters are generally equal to each other.

In some examples, the restriction orifice of each intermediate orifice plate is eccentric relative to the restriction orifices of the upstream and downstream orifice plates.

In some examples, the restriction orifice of the upstream orifice plate is concentric with the conduit inlet and the restriction orifice of the downstream orifice plate is concentric with the conduit outlet.

In some examples, the injection system includes a plurality of the intermediate orifice plates, and the restriction orifices of the intermediate orifice plates are eccentric relative to each other.

In some examples, the restriction orifices of at least two of the intermediate orifice plates have center points spaced circumferentially apart from each other about the passage axis by about 180 degrees.

In some examples, the conduit inlet and the conduit outlet are concentric with each other and the passage axis.

In some examples, the injection system further includes a plurality of solenoid valves upstream of corresponding injection ports for controlling injection of the treatment fluid through each injection port individually.

In some examples, the untreated fuel stored in the fuel storage tank comprises petroleum diesel and the treatment fluid comprises biodiesel.

According to some aspects, a retail fueling station is configured to treat untreated fuel to produce treated fuel for delivery to end users at the retail fueling station. The retail fueling station includes: (a) a fuel supply line extending between a fuel storage tank and a fuel dispensing system of the retail fueling station; (b) a treatment fluid supply line coupled to a treatment fluid storage tank; and (c) a treatment fluid injection system including: (i) a mixing conduit mounted to the fuel supply line and through which untreated fuel flows when conducted through the fuel supply line from the fuel storage tank toward the fuel dispensing system; (ii) one or more pressure reducers in the mixing conduit for providing a reduced pressure region immediately downstream of each pressure reducer; and (iii) one or more injection ports in the mixing conduit for injection of treatment fluid received from the treatment fluid supply line into corresponding reduced pressure regions for mixture with the untreated fuel flowing through the mixing conduit.

In some examples, the one or more pressure reducers comprise a plurality of restriction orifices arranged in series within the mixing conduit.

In some examples, the supply line is defined by a supply line inner diameter, and the mixing conduit has an expanded section in which the restriction orifices are located, the expanded section defined by an expanded inner diameter greater than the supply line inner diameter.

In some examples, each restriction orifice has a corresponding orifice diameter that is greater than the supply line inner diameter and less than the expanded inner diameter.

In some examples, at least two of the restriction orifices are eccentric relative to each other.

According to some aspects, an injection system is for configuring a retail fueling station to treat untreated fuel to produce treated fuel for delivery to end users at the retail fueling station. The injection system includes: (a) a mixing conduit for mounting to a fuel supply line extending between a fuel storage tank for storing untreated fuel and a fuel dispensing system for dispensing treated fuel to the end users. The mixing conduit has a conduit inlet for fluid connection with an upstream portion of the fuel supply line for receiving the untreated fuel from the fuel storage tank, a conduit outlet for fluid connection with a downstream portion of the fuel supply line for discharging treated fuel toward the fuel dispensing system, and a fluid passage extending through the conduit between the conduit inlet and the conduit outlet along a passage axis. The injection system further includes (b) a plurality of orifice plates arranged in series in the mixing conduit. The orifice plates are spaced axially apart from each other along the passage axis and axially separate the fluid passage into a plurality of mixing chambers. Each orifice plate has a restriction orifice sized for providing a reduced pressure region immediately downstream of the orifice plate. The injection system further includes (c) a plurality of injection ports in the mixing conduit. Each injection port has a port inlet for receiving treatment fluid from a treatment fluid supply line and a port outlet open to the reduced pressure region of a corresponding mixing chamber for injection of the treatment fluid therein for mixture with untreated fuel flowing through the mixing chamber. The injection system further includes (d) one or more solenoid valves positioned upstream of the injection ports for controlling injection of the treatment fluid through the injection ports.

In some examples, the injection system includes a plurality of the solenoid valves positioned upstream of corresponding injection ports for controlling injection of the treatment fluid through each injection port individually.

In some examples, the conduit inlet and outlet are generally cylindrical and defined by respective inlet and outlet inner diameters, and the mixing conduit has a cylindrical expanded section in which the orifice plates and mixing chambers are located, the expanded section defined by an expanded inner diameter greater than the inlet and outlet inner diameters.

In some examples, the mixing conduit has a conical divergent section between the conduit inlet and the expanded section and expanding radially in the downstream direction from the inlet inner diameter to the expanded inner diameter, and a conical convergent section between the expanded section and the conduit and converging radially in the downstream direction from the expanded inner diameter to the outlet inner diameter.

In some examples, the restriction orifice of each orifice plate is defined by a corresponding orifice diameter, and each orifice diameter is greater than the inlet and outlet inner diameters and less than the expanded inner diameter.

In some examples, the restriction orifices of at least two of the orifice plates are eccentric relative to each other.

According to some aspects, a method of treating untreated fuel at a retail fueling station includes: (a) pumping untreated fuel from a fuel storage tank toward a fuel dispensing system through a fuel supply line; (b) during (a), conducting the fuel through at least one fluid pressure reducer in a mixing conduit mounted to the fuel supply line to reduce fluid pressure of the untreated fuel in a reduced pressure region immediately downstream of the fluid pressure reducer; and (c) injecting treatment fluid into the reduced pressure region through one or more injection ports for blending with the untreated fuel flowing through the mixing conduit.

In some examples, the untreated fuel comprises petroleum diesel and the treatment fluid comprises biodiesel.

In some examples, the untreated fuel is pumped toward the mixing conduit at a supply pressure, and the treatment fluid is injected through the one or more injection ports at an injection pressure generally equal to or less than the supply pressure and greater than the fluid pressure in the reduced pressure region.

In some examples, the at least one pressure reducer comprises a plurality of restriction orifices arranged in series, and (c) includes injecting the treatment fluid into a corresponding reduced pressure region immediately downstream of each restriction orifice.

In some examples, at least two of the restriction orifices are eccentric relative to each other.

In some examples, the method further includes conducting the untreated fuel into an expanded section of the mixing conduit having an expanded inner diameter greater than a supply line inner diameter of the fuel supply line, the restriction orifices and reduced pressure regions located in the expanded section.

In some examples, the restriction orifice has an orifice diameter greater than the supply line inner diameter and less than the expanded inner diameter.

According to some aspects, a method of retrofitting a pre-existing retail fueling station for treatment of untreated fuel to produce treated fuel for delivery to end users at the retail fueling station includes: (a) installing a mixing conduit on a fuel supply line of the retail fueling station, the fuel supply line extending between a fuel storage tank for storing untreated fuel and a fuel dispensing system for dispensing treated fuel to the end users; and (b) connecting a treatment fluid supply line to one or more injection ports in the mixing conduit for supplying treatment fluid from a treatment fluid storage tank to the one or more injection ports. Each injection port is open to a reduced pressure region immediately downstream of a pressure reducer in the mixing conduit for injection of treatment fluid into the reduced pressure region for blending with untreated fuel flowing through the mixing conduit toward the fuel dispensing system.

In some examples, the untreated fuel comprises petroleum diesel and the treatment fluid comprises biodiesel.

### BRIEF DESCRIPTION OF THE DRAWINGS

The drawings included herewith are for illustrating various examples of apparatuses, systems, and processes of the present specification and are not intended to limit the scope of what is taught in any way. In the drawings:

FIG. 1 is a schematic of an example retail fueling station with an integrated fuel treatment system;

FIG. 2 is a perspective cross-sectional view of mixing conduit portions of the retail fueling station of FIG. 1;

FIG. 2A is an enlarged view of a portion of FIG. 2; and

FIG. 3 is a perspective cross-sectional view like that of FIG. 2, and showing a flow simulation of untreated fuel mixing with treatment fluid during flow through the mixing conduit portions of the retail fueling station of FIG. 1.

### DETAILED DESCRIPTION

Various apparatuses, systems, or processes will be described below to provide an example of an embodiment of each claimed invention. No embodiment described below limits any claimed invention and any claimed invention may cover apparatuses, systems, or processes that differ from those described below. The claimed inventions are not limited to apparatuses, systems, or processes having all of the features of any one apparatus, system, or process described below or to features common to multiple or all of the apparatuses, systems, or processes described below. It is possible that an apparatus, system, or process described below is not an embodiment of any claimed invention. Any invention disclosed in an apparatus, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

Fuel treatment can involve blending untreated fuel with one or more fuel treatment fluids to produce treated fuel. Fuel treatment can often take place at tanker truck fill stations or elsewhere prior to transport and delivery of the fuel to retail fueling stations for dispensing to end users. In some cases, it is desirable to treat fuel at the retail fueling station itself, for example, to provide retail fueling stations with more control over the type and quantity of treatment fluids used for treating fuel. In some examples, the untreated fuel can include petroleum diesel and the treatment fluids can include biodiesel for blending with the petroleum diesel to produce treated fuel in the form of a blend of biodiesel and petroleum diesel at a ratio determined at the retail fueling station. In some examples, the biodiesel can be, for example, pure (B100) biodiesel and the treated fuel can be a blend of 6-20% biodiesel with 80-94% petroleum diesel (i.e. B6-B20 biodiesel). Other treatment fluids, such as one or more fuel additives, can also be blended in predetermined amounts with the untreated fuel to adjust one or more properties of the fuel.

The present disclosure is directed to aspects of fuel treatment systems that can be integrated into retail fueling stations and are suitable for blending one or more treatment fluids (e.g. biodiesel and/or one or more other treatment fluids) with a stream of untreated fuel (e.g. petroleum diesel) to produce treated fuel for dispensing to end users. As used herein, the term “untreated fuel” means fuel that has not yet been fully treated with treatment fluid added by the fuel treatment systems of the present disclosure. The term “treated fuel” as used herein means fuel that has been treated with treatment fluid added by the fuel treatment systems of the present disclosure. The untreated fuel may comprise additives or a blend of fuels prior to further treatment by the fuel treatment system of the present disclosure. The untreated fuel is an input into the treatment systems of the present disclosure, and in some examples the untreated fuel is a B3-B5 biodiesel blend. Treatment systems according to the present disclosure will, in some examples, treat the untreated B3-B5 to produce (as an output) a treated fuel that is a B6-B20 biodiesel blend, ready for dispensing to an end user (e.g. the fuel tank of an end user's vehicle).

The fuel treatment systems according to some examples of the present disclosure are installed at retail fueling stations for injection of treatment fluid into a stream of untreated fuel flowing through a fuel supply line that extends from a fuel storage tank (for storing the untreated fuel) to a fuel dispensing system (for dispensing treated fuel to end users). The fuel treatment systems of the present disclosure, are in some examples, advantageously configured for use with standard equipment and fluid line pressures normally used at the retail fueling station. This can help reduce costs and simplify installation, maintenance, and/or use of the fuel treatment system (and the retail fueling station) by, for example, not necessarily requiring higher pressure (above standard fluid line pressures) in the treatment system in order to inject a treatment fluid into the untreated fuel line (operating at standard pressure).

For example, a standard fluid line pressure at existing retail fueling stations is typically about 275 kPa (around 40 psi). Pumps, hoses, and lines are installed to operate at this pressure. To add a treatment fluid into a fluid line, the treatment fluid needs to be injected at a pressure higher than the pressure of the fluid line. Following conventional wisdom, a person would be inclined to provide a higher pressure pump on the treatment fluid delivery system, with related higher-pressure-capable components in the delivery lines. However, higher pressure pumps are more costly, and mixing higher pressure (non-standard) equipment with standard pressure equipment can, in addition to increasing cost, complicate maintenance and introduce undesirable risk.

These drawbacks are mitigated by examples of the present disclosure in which fuel treatment systems have one or more low-pressure mixing sections along the untreated fuel flow path, with treatment fluid delivery outlets positioned along the low-pressure mixing sections for introducing one or more treatment fluids into the untreated fuel stream. In some examples, pressure reducers (e.g. restriction orifices) are positioned in the fuel supply line to reduce fluid pressure of fuel flowing through the mixing sections. The pressure in the low pressure mixing sections is, in some examples, less than the standard pressures normally used at the retail fueling station. In some examples, the pressure in the mixing sections is from about 25 kPa to about 50 kPa below standard pressure. Treatment fluid supplied at or near standard pressures (e.g. from about 25 kPa to about 50 kPa above the pressure in the mixing section) can then be injected into the mixing sections without risk of backflow of the untreated fuel into the treatment fluid delivery lines. The fuel treatment systems of the present disclosure may also facilitate improved blending of the treatment fluid with the fuel by, for example, inducing turbulent and/or recirculatory flow of the fuel flowing through mixing sections (e.g. by passing the fuel through one or more restriction orifices and/or expanded diameter sections between the restriction orifices).

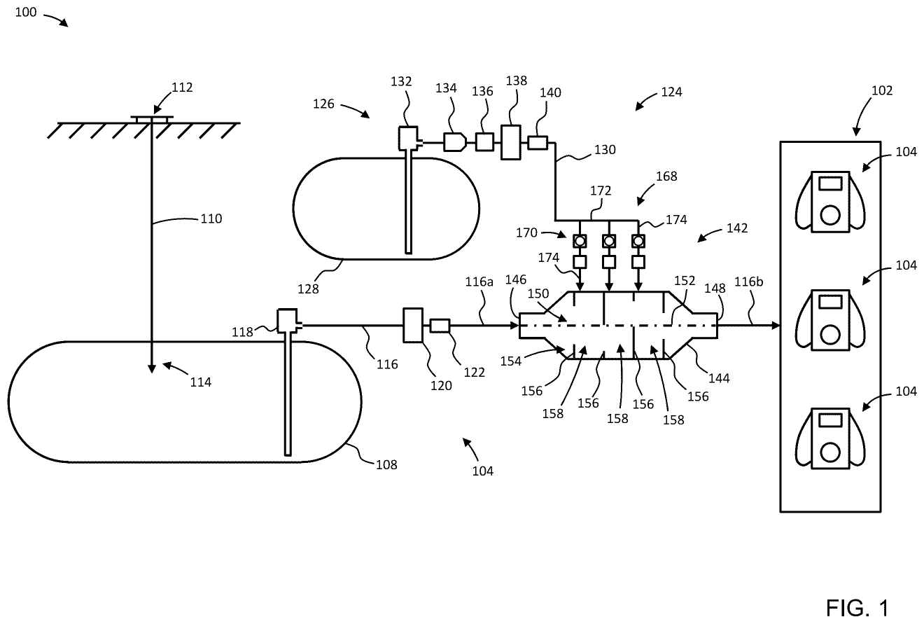

Referring to FIG. 1, an example retail fueling station 100 configured to treat fuel for dispensing to end users at the retail fueling station 100 is illustrated schematically. In the example illustrated, the retail fueling station 100 includes a fuel dispensing system 102 having one or more fuel dispensers 104 for dispensing treated fuel to the end users. The retail fueling station 100 further includes a fuel supply system 106 for supplying fuel to the fuel dispensing system 102. In the example illustrated, the fuel supply system 106 includes an underground fuel storage tank 108 for storing untreated fuel. A tank filling line 110 extends between a fuel inlet 112 accessible from above ground for receiving the untreated fuel from a nozzle (e.g. of a refueling tanker truck) and a fuel outlet 114 in fluid communication with the fuel storage tank 108 for discharging the fuel into the fuel storage tank 108. In the example illustrated, the untreated fuel stored in the fuel storage tank 108 comprises petroleum diesel. In some examples, the untreated fuel stored in the storage tank 108 is a low-level biodiesel blend, such as B5.

In the example illustrated, the fuel supply system 106 further includes a fuel supply line 116 extending between the fuel storage tank 108 and the fuel dispensing system 102, and a fuel pump 118 for pumping the untreated fuel from the fuel storage tank 108 toward the fuel dispensing system 102 through the fuel supply line 116. In the example illustrated, a meter 120 and valve 122 are provided on the fuel supply line 116 downstream of the fuel pump 118.

In the example illustrated, the fueling station 100 further includes a fuel treatment system 124 for treating untreated fuel flowing through the supply line 116 with a treatment fluid to produce the treated fuel for dispensing to the end users. In the example illustrated, the treatment fluid comprises near-pure or pure biodiesel (e.g. B100 biodiesel) for blending with the untreated fuel to produce the treated fuel in the form of a desired blend of biodiesel and petroleum diesel (e.g. B20 biodiesel).

In the example illustrated, the fuel treatment system 124 includes a treatment fluid supply system 126 including a treatment fluid storage tank 128 for storing the treatment fluid, a treatment fluid supply line 130 coupled to the treatment fluid storage tank 128 for receiving the treatment fluid therefrom, and a treatment fluid pump 132 coupled to the treatment fluid supply line 130 for pumping the treatment fluid from the treatment fluid storage tank 128 through the treatment fluid supply line 130. In the example illustrated, a pipe reducer 134, strainer 136, meter 138, and valve 140 are provided on the treatment fluid supply line 130 downstream of the treatment fluid pump 132.

In the example illustrated, the fuel treatment system 124 includes a treatment fluid injection system 142 on the fuel supply line 116 for injection of the treatment fluid into a stream of untreated fuel flowing through the fuel supply line 116. In the example illustrated, the injection system 142 includes a mixing conduit 144 mounted to the fuel supply line 116. The mixing conduit 144 has a conduit inlet 146 in fluid communication with an upstream portion 116a of the fuel supply line 116 for receiving untreated fuel from the fuel storage tank 108, a conduit outlet 148 in fluid communication with a downstream portion 116b of the fuel supply line 116 for discharging treated fuel toward the fuel dispensing system 102, and a fluid passage 150 extending through the mixing conduit 144 between the conduit inlet 146 and the conduit outlet 148 along a passage axis 152.

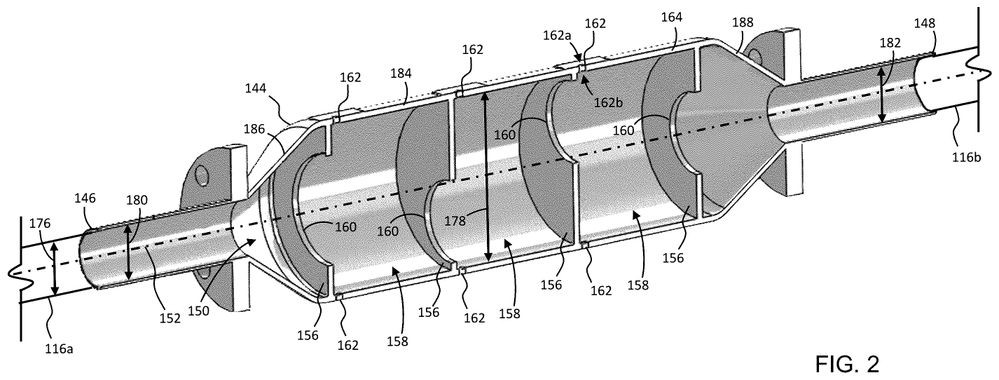

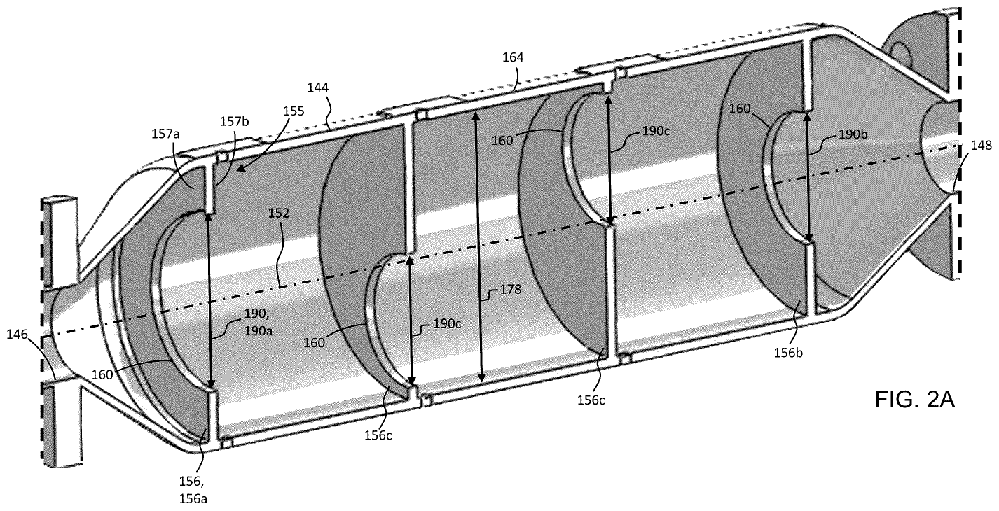

In the example illustrated, one or more pressure reducers 154 are positioned in the mixing conduit 144 for providing a reduced pressure region 155 (FIG. 2A) immediately downstream of each pressure reducer 154. Referring to FIG. 2, in the example illustrated, the injection system 142 includes a plurality of the pressure reducers 154 in the form of orifice plates 156 arranged in series in the mixing conduit 144. The orifice plates 156 are spaced axially apart from each other along the passage axis 152 and axially separate the fluid passage into a plurality of mixing chambers 158. Each orifice plate 156 has a restriction orifice 160 sized for providing a corresponding reduced pressure region in the mixing chamber 158 immediately downstream of the orifice plate 156. Such an arrangement may also help induce turbulent and recirculatory flow of fuel within the mixing chambers 158, which can facilitate blending of the treatment fluid with the untreated fuel flowing through the mixing conduit 144. Referring to FIG. 2A, in the example illustrated, each orifice plate 156 has an upstream surface 157a directed toward the conduit inlet 146 and a downstream surface 157b axially opposite the upstream surface 157a and directed toward the conduit outlet 148. In the example illustrated, each of the upstream surface 157a and the downstream surface 157b extends circumferentially about a corresponding restriction orifice 160, and radially between the restriction orifice 160 and the conduit sidewall 164. In the example illustrated, each reduced pressure region 155 is downstream and proximate the downstream surface 157b of a corresponding orifice plate 156.

Referring to FIG. 2, in the example illustrated, the mixing conduit 144 has one or more injection ports 162 for injection of treatment fluid received from the treatment fluid supply line 130 into corresponding reduced pressure regions in the mixing chambers 158 for mixture with untreated fuel flowing through the mixing conduit 144. In the example illustrated, the injection system 142 includes a plurality of injection ports 162. In the example illustrated, the mixing conduit 144 has a cylindrical conduit sidewall 164 extending along the passage axis 152 and radially bounding the fluid passage 150, and the injection ports 162 extend radially through the conduit sidewall 164. Each injection port 162 has a port inlet 162a coupled to the treatment fluid supply line 130 (FIG. 1) for receiving treatment fluid therefrom and a port outlet 162b open to the reduced pressure region of a corresponding mixing chamber 158 for injection of the treatment fluid therein for mixture with untreated fuel flowing through the mixing chamber 158. In the example illustrated, at least two injection ports 162 are open to the reduced pressure region of each mixing chamber 158 and are spaced circumferentially apart from each other about the passage axis 152 for injection of treatment fluid into the mixing chamber 158 from different directions about the flow passage 150.

Referring to FIG. 1, in the example illustrated, the treatment fluid supply system 126 includes a manifold 168 for distributing treatment fluid from the treatment fluid supply line 130 to each of the plurality of injection ports 162 (FIG. 2). In the example illustrated, the manifold 168 includes a manifold header 172 in fluid communication with the treatment fluid supply line 130 for receiving treatment fluid therefrom, and a plurality of manifold lines 174 extending between the manifold header 172 and corresponding injection ports 162 (FIG. 2) for conducting treatment fluid from the manifold header 172 to each injection port 162 (FIG. 2). In the example illustrated, each manifold line 174 has a corresponding solenoid valve 170 for controlling flow of treatment fluid therethrough. Each solenoid valve 170 is individually controllable for controlling injection of the treatment fluid through each injection port 162 individually. This can facilitate controlled selection and/or adjustment of a blend ratio of the untreated fuel and treatment fluid at the retail fueling station (e.g. to allow for adjustment of the blend ratio from, for example, 6-20% biodiesel with 80-94% petroleum diesel (B6-B20 biodiesel) depending on demand and/or availability of biodiesel at the retail fueling station).

In some examples, the fuel supply system 106 and/or treatment fluid supply system 126 can comprise pre-existing equipment at the retail fueling station 100 rated for standard fluid pressures normally used at the retail fueling station 100. In the example illustrated, the fuel supply system 106 (including the fuel pump 118 and supply line 116) is configured to conduct and supply the untreated fuel to the conduit inlet 146 at a standard supply pressure, and the treatment fluid supply system 126 (including the treatment fluid pump 132 and supply line 130) is configured to conduct and supply the treatment fluid to each injection port 162 at an injection pressure that is equal to (or in some examples, less than) the standard supply pressure. In such examples, untreated fuel is conducted through the reduced pressure regions at a reduced fluid pressure that is less than the supply and injection pressures to facilitate injection of the treatment fluid for blending with the untreated fuel in the reduced pressure regions of the mixing chambers 158.

Referring to FIG. 2, in the example illustrated, the fuel supply line 116 has a supply line cross-sectional area and each mixing chamber 158 has an expanded cross-sectional area that is greater than the supply line cross-sectional area. In the example illustrated, the supply line cross-sectional area is defined by a supply line inner diameter 176, and the expanded cross-sectional area is defined by an expanded inner diameter 178 that is greater than the supply line inner diameter 176. In the example illustrated, the conduit inlet 146 and outlet 148 have respective inlet and outlet cross-sectional areas. In the example illustrated, the inlet and outlet cross-sectional areas correspond to the supply line cross-sectional area. In the example illustrated, the inlet and outlet cross-sectional areas are generally cylindrical and defined by respective inlet and outlet inner diameters 180, 182. In the example illustrated, each of the inlet and outlet inner diameters 180, 182 correspond to the supply line inner diameter 176, and the mixing conduit 144 has a cylindrical expanded section 184 defined by the expanded inner diameter 178 and in which the orifice plates 156 and mixing chambers 158 are located. In the example illustrated, the mixing conduit 144 has a conical divergent section 186 between the conduit inlet 146 and the expanded section 184 and expanding radially in the downstream direction from the inlet inner diameter 180 to the expanded inner diameter 178, and a conical convergent section 188 between the expanded section 184 and the conduit outlet 148 and converging radially in the downstream direction from the expanded inner diameter 178 to the outlet inner diameter 182.

Referring to FIG. 2A, in the example illustrated, the restriction orifice 160 of each orifice plate 156 has an orifice cross-sectional area that is greater than the supply line cross-sectional area and less than the expanded cross sectional area. In the example illustrated, the orifice cross-sectional area of each restriction orifice 160 is defined by a corresponding orifice diameter 190. In the example illustrated, each orifice diameter 190 is greater than the supply line inner diameter 176 (and the inlet and outlet inner diameters 180, 182—see FIG. 2) and less than the expanded inner diameter 178.

Referring to FIG. 2, in the example illustrated, the restriction orifice 160 of at least one of the orifice plates 156 is eccentric relative to at least one of the conduit inlet 146 and the conduit outlet 148. Such eccentricity may further facilitate blending of the untreated fuel with the treatment fluid injected into the mixing chambers 158. In the example illustrated, at least two of the orifice plates 156 are eccentric to both the conduit inlet 146 and the conduit outlet 148. In the example illustrated, the restriction orifices 160 of at least two of the orifice plates 156 are eccentric relative to each other.

Referring to FIG. 2A, in the example illustrated, the plurality of orifice plates 156 include an upstream orifice plate 156a adjacent the conduit inlet 146, a downstream orifice plate 156b adjacent the conduit outlet 148, and one or more intermediate orifice plates 156c between the upstream and downstream orifice plates 156a, 156b. In the example illustrated, the restriction orifice 160 of the upstream orifice plate 156a is concentric with the conduit inlet 146, and the restriction orifice 160 of the downstream orifice plate 156b is concentric with the conduit outlet 148. In the example illustrated, the conduit inlet 146 and the conduit outlet 148 are concentric relative to each other and the passage axis 152.

In the example illustrated, the restriction orifice 160 of each intermediate orifice plate 156c is eccentric relative to the restriction orifices 160 of the upstream and downstream orifice plates 156a, 156b. In the example illustrated, the injection system 142 includes a plurality of the intermediate orifice plates 156c, and the restriction orifices 160 of the intermediate orifice plates 156c are eccentric relative to each other. In the example illustrated, two intermediate orifice plates 156c are provided in the mixing conduit 144, and the restriction orifices 160 of the intermediate orifice plates 156c are eccentric relative to the passage axis 152 and have center points spaced circumferentially apart from each other about the passage axis 152 by about 180 degrees.

In the example illustrated, the restriction orifice 160 of the upstream orifice plate 156a has an orifice cross-sectional area defined by an upstream orifice diameter 190a, the restriction orifice 160 of the downstream orifice plate 156b has an orifice cross-sectional area defined by a downstream orifice diameter 190b, and the restriction orifice 160 of each intermediate orifice plate 156c has an orifice cross-sectional area defined by a corresponding intermediate orifice diameter 190c. In the example illustrated, the upstream orifice diameter 190a is greater than the downstream and intermediate orifice diameters 190b, 190c. Each of the intermediate and downstream orifice diameters 190b, 190c are generally equal to each other in the example illustrated.

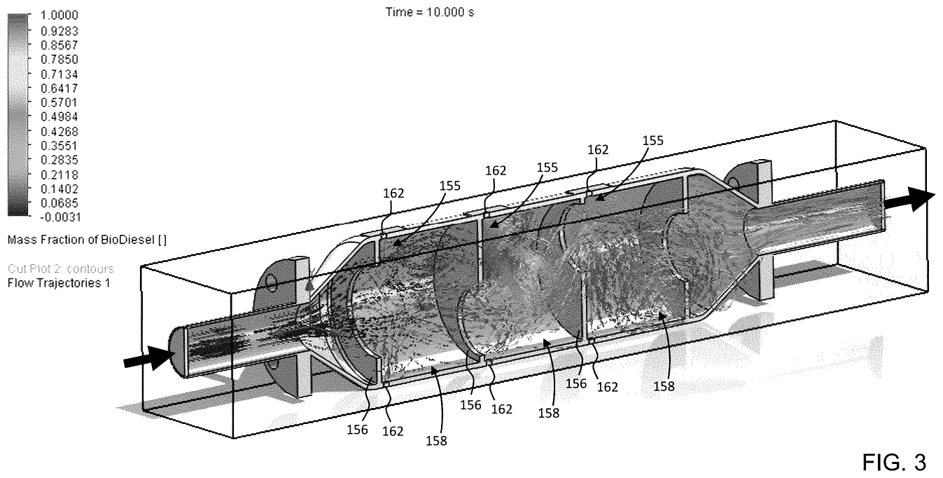

Referring to FIG. 1, in use, untreated fuel is pumped from the fuel storage tank 108 and conducted through the fuel supply line 116 at the supply pressure toward the fuel dispensing system 102. The untreated fuel is conducted through the pressure reducers 154 (e.g. restriction orifice plates 156) in the mixing conduit 144 to reduce fluid pressure of the fuel in a reduced pressure region immediately downstream of the fluid pressure reducers 154. The treatment fluid is injected into corresponding reduced pressure regions through the injection ports 162 (FIG. 2) at the injection pressure for blending with the untreated fuel flowing through the mixing chambers 158 in the mixing conduit 144 to produce treated fuel (see also FIG. 3). The treated fuel is discharged from the mixing conduit 144 and conducted to the fuel dispensing system 102 for dispending of the treated fuel to end users at the retail fueling station 100.

Pre-existing retail fueling stations can be retrofitted for treatment of fuel as disclosed herein. Retrofitting pre-existing retail fueling stations includes installing the mixing conduit 144 on pre-existing fuel supply line 116 and connecting a pre-existing (or provided) treatment fluid supply line 130 to the injection ports 162 in the mixing conduit 144 (e.g. through the manifold 168) for supplying treatment fluid from a pre-existing (or provided) treatment fluid storage tank 128 to the injection ports 162 (FIG. 2).

1. A retail fueling station configured to treat untreated fuel to produce treated fuel for delivery to end users at the retail fueling station, the retail fueling station comprising:
a) a fuel dispensing system including at least one fuel dispenser for dispensing treated fuel to the end users;
b) a fuel supply system including an underground fuel storage tank for storing untreated fuel, a fuel supply line extending between the fuel storage tank and the fuel dispensing system, and a fuel pump coupled to the fuel supply line for pumping the untreated fuel from the fuel storage tank toward the fuel dispensing system through the fuel supply line;
c) a treatment fluid supply system including a treatment fluid storage tank for storing a treatment fluid, a treatment fluid supply line coupled to the treatment fluid storage tank for receiving the treatment fluid therefrom, and a treatment fluid pump coupled to the treatment fluid supply line for pumping the treatment fluid from the treatment fluid storage tank through the treatment fluid supply line;
d) a treatment fluid injection system including:
i) a mixing conduit mounted to the fuel supply line, the mixing conduit having a conduit inlet in fluid communication with an upstream portion of the fuel supply line for receiving the untreated fuel from the fuel storage tank, a conduit outlet in fluid communication with a downstream portion of the fuel supply line for discharging the treated fuel toward the fuel dispensing system, and a fluid passage extending through the conduit between the conduit inlet and the conduit outlet along a passage axis;
ii) a plurality of orifice plates arranged in series in the mixing conduit, the orifice plates spaced axially apart from each other along the passage axis and axially separating the fluid passage into a plurality of mixing chambers, each orifice plate having a restriction orifice sized for providing a reduced pressure region in the mixing chamber immediately downstream of the orifice plate; and
iii) a plurality of injection ports in the mixing conduit, each injection port having a port inlet for receiving treatment fluid from the treatment fluid supply line and a port outlet open to the reduced pressure region of a corresponding mixing chamber for injection of the treatment fluid therein for mixture with untreated fuel flowing through the mixing chamber.

2. The retail fueling station of claim 1, wherein the fuel supply system is configured to supply the untreated fuel to the conduit inlet at a supply pressure, the treatment fluid supply system is configured to supply the treatment fluid to each injection port at an injection pressure equal to or less than the supply pressure, and each reduced pressure region provides a reduced fluid pressure that is less than the injection pressure.

3. The retail fueling station of claim 1, wherein the fuel supply line is defined by a supply line inner diameter and each mixing chamber is defined by an expanded inner diameter, the expanded inner diameter greater than the supply line inner diameter.

4. The retail fueling station of claim 3, wherein the conduit inlet and outlet are generally cylindrical and defined by respective inlet and outlet inner diameters, each of the inlet and outlet inner diameters corresponding to the supply line inner diameter, and the mixing conduit has a cylindrical expanded section defined by the expanded inner diameter and in which the orifice plates and mixing chambers are located.

5. The retail fueling station of claim 4, wherein the mixing conduit has a conical divergent section between the conduit inlet and the expanded section and expanding radially in a downstream direction from the inlet inner diameter to the expanded inner diameter, and a conical convergent section between the expanded section and the conduit outlet and converging radially in the downstream direction from the expanded inner diameter to the outlet inner diameter.

6. The retail fueling station of claim 3, wherein the restriction orifice of each orifice plate is defined by a corresponding orifice diameter, and each orifice diameter is greater than the supply line inner diameter and less than the expanded inner diameter.

7. The retail fueling station of claim 1, wherein the restriction orifices of at least two of the orifice plates are eccentric relative to each other.

8. The retail fueling station of claim 1, wherein the restriction orifice of at least one of the orifice plates is eccentric relative to at least one of the conduit inlet and the conduit outlet.

9. The retail fueling station of claim 1, wherein the plurality of orifice plates include an upstream orifice plate adjacent the conduit inlet, a downstream orifice plate adjacent the conduit outlet, and one or more intermediate orifice plates between the upstream and downstream orifice plates.

10. The retail fueling station of claim 9, wherein the restriction orifice of the upstream orifice plate is defined by an upstream orifice diameter, the restriction orifice of the downstream orifice plate is defined by a downstream orifice diameter, and the restriction orifice of each intermediate orifice is defined by a corresponding intermediate orifice diameter, and wherein the upstream orifice diameter is greater than the downstream and intermediate orifice diameters.

11. The retail fueling station of claim 10, wherein the intermediate and downstream orifice diameters are generally equal to each other.

12. The retail fueling station of claim 9, wherein the restriction orifice of each intermediate orifice plate is eccentric relative to the restriction orifices of the upstream and downstream orifice plates.

13. The retail fueling station of claim 9, wherein the restriction orifice of the upstream orifice plate is concentric with the conduit inlet and the restriction orifice of the downstream orifice plate is concentric with the conduit outlet.

14. An injection system for configuring a retail fueling station to treat untreated fuel to produce treated fuel for delivery to end users at the retail fueling station, the injection system comprising:
a) a mixing conduit for mounting to a fuel supply line extending between a fuel storage tank for storing untreated fuel and a fuel dispensing system for dispensing treated fuel to the end users, the mixing conduit having a conduit inlet for fluid connection with an upstream portion of the fuel supply line for receiving the untreated fuel from the fuel storage tank, a conduit outlet for fluid connection with a downstream portion of the fuel supply line for discharging treated fuel toward the fuel dispensing system, and a fluid passage extending through the conduit between the conduit inlet and the conduit outlet along a passage axis;
b) a plurality of orifice plates arranged in series in the mixing conduit, the orifice plates spaced axially apart from each other along the passage axis and axially separating the fluid passage into a plurality of mixing chambers, each orifice plate having a restriction orifice sized for providing a reduced pressure region immediately downstream of the orifice plate; and
c) a plurality of injection ports in the mixing conduit, each injection port having a port inlet for receiving treatment fluid from a treatment fluid supply line and a port outlet open to the reduced pressure region of a corresponding mixing chamber for injection of the treatment fluid therein for mixture with untreated fuel flowing through the mixing chamber; and
d) one or more solenoid valves positioned upstream of the injection ports for controlling injection of the treatment fluid through the injection ports.

15. The injection system of claim 14, wherein the injection system includes a plurality of the solenoid valves positioned upstream of corresponding injection ports for controlling injection of the treatment fluid through each injection port individually.

16. The injection system of claim 14, wherein the conduit inlet and outlet are generally cylindrical and defined by respective inlet and outlet inner diameters, and the mixing conduit has a cylindrical expanded section in which the orifice plates and mixing chambers are located, the expanded section defined by an expanded inner diameter greater than the inlet and outlet inner diameters.

17. The injection system of claim 16, wherein the restriction orifice of each orifice plate is defined by a corresponding orifice diameter, and each orifice diameter is greater than the inlet and outlet inner diameters and less than the expanded inner diameter.

18. A method of treating untreated fuel at a retail fueling station, comprising:
a) pumping untreated fuel from a fuel storage tank toward a fuel dispensing system through a fuel supply line;
b) during (a), conducting the fuel through at least one fluid pressure reducer in a mixing conduit mounted to the fuel supply line to reduce fluid pressure of the untreated fuel in a reduced pressure region immediately downstream of the fluid pressure reducer; and
c) injecting treatment fluid into the reduced pressure region through one or more injection ports for blending with the untreated fuel flowing through the mixing conduit.

19. The method of claim 18, wherein the untreated fuel is pumped toward the mixing conduit at a supply pressure, and the treatment fluid is injected through the one or more injection ports at an injection pressure generally equal to or less than the supply pressure and greater than the fluid pressure in the reduced pressure region.

20. The method of claim 18, further comprising conducting the untreated fuel into an expanded section of the mixing conduit having an expanded inner diameter greater than a supply line inner diameter of the fuel supply line, the restriction orifices and reduced pressure regions located in the expanded section.
